(19) United States
(12) Patent Application Publication
(10) Pub. No.: US 2023/0213155 A1
(43) Pub. Date: Jul. 6, 2023

(54) COLUMN AND A COMBINED LAMP WITH THE COLUMN

(71) Applicant: Ching-Hui CHEN, Huizhou (CN)

(72) Inventor: Ching-Hui CHEN, Huizhou (CN)

(21) Appl. No.: 17/989,714

(22) Filed: Nov. 18, 2022

(30) Foreign Application Priority Data
Jan. 6, 2022 (CN) 202220039181.9

(51) Int. Cl. F21S 4/28; F21S 8/02; F21V 23/06; F21V 23/00

(52) U.S. Cl. CPC F21S 4/28; F21S 8/024; F21V 23/06; F21V 23/003; F21Y 2115/10

(57) ABSTRACT

The present utility model discloses a column and a combined lamp equipped with the column, the column in the present utility model can be formed by a single column body or formed by a plurality of columns which are connected in a vertically adjacent manner; the LED light strips on two adjacent columns can be connected via the conductive subassembly; when the column is used to form the frame of the combined lamp, the LED light strip(s) arranged on the column body can be used for lighting to increase the illumination intensity of the combined lamp and the diversity of the frame of the combined lamp and thus improve the practicability of the combined lamp.

### BACKGROUND OF THE INVENTION

The present utility model relates to the technical field of lamps, in particular relates to a column and a combined lamp with the column.

The floor lamps belong to combined lamps. In the prior art, a floor lamp generally comprises a column, a partition board, a light source and a lampshade; the partition board is arranged inside the frame composed of multiple columns, the light source and the lampshade are located at the top of the frame; the frame of such floor lamp has a simple shape and does not have diversity; when the frame is high as a whole, the light source and the lampshade will be also located at a high position, which causes insufficient illumination intensity around the frame and thus reduces the practicability.

### BRIEF SUMMARY OF THE INVENTION

The main purpose of the present utility model is to provide a column and a combined lamp with the column, aiming to improve the illumination intensity and practicability of the combined lamp.

In order to realize the above purpose, the present utility model provides a column comprising an LED light strip, a conductive subassembly and at least one hollow column body, wherein on the side of the column body is arranged with a light-transmitting opening connected to the hollow area of the column body, on the said light-transmitting opening is arranged with a light-transmitting sheet, and the said LED light strip is mounted in the column body, the said conductive subassembly is electrically connected with the LED light strip for connecting the LED light strip with the external power supply.

The present utility model also provides a combined lamp comprising a column, wherein the said column is the aforementioned column.

In the technical solution of the present utility model, the column apparatus used for the combined lamp is arranged as at least one hollow column body, and in the hollow area of the column body is arranged with LED light strip(s); on the side of the column body is arranged with a light-transmitting opening connected to the hollow area of the column body, on the light-transmitting opening is arranged with a light-transmitting sheet as well as a conductive subassembly electrically connected to the LED light strip(s); the column in the present utility model can be formed by a single column body or formed by a plurality of columns which are connected in a vertically adjacent manner; the LED light strips on two adjacent columns can be connected via the conductive subassembly; when the column is used to form the frame of the combined lamp, the LED light strip(s) arranged on the column body can be used for lighting to increase the illumination intensity of the combined lamp and the diversity of the frame of the combined lamp and thus improve the practicability of the combined lamp.

### BRIEF DESCRIPTION OF THE DRAWINGS

FIG. 1 is a perspective view of Embodiment I of the column body;

FIG. 2 is a perspective view of Embodiment II of the column body at the first angle;

FIG. 3 is a perspective view of Embodiment II of the column body at the second angle;

FIG. 4 is a perspective view of Embodiment III of the column body;

FIG. 5 is a perspective view of the connecting piece;

FIG. 6 is a sectional view of the column body when its upper end and its lower end are equipped with a first screw aperture and a slot respectively;

FIG. 7 is a sectional view of the column body when its upper end and its lower end are equipped with a male power connector and a lot respectively;

FIG. 8 is a sectional view of the column body when its upper end and its lower end are equipped with a male power connector and a second screw aperture respectively;

FIG. 9 is a sectional view when multiple column bodies are assembled to form a column;

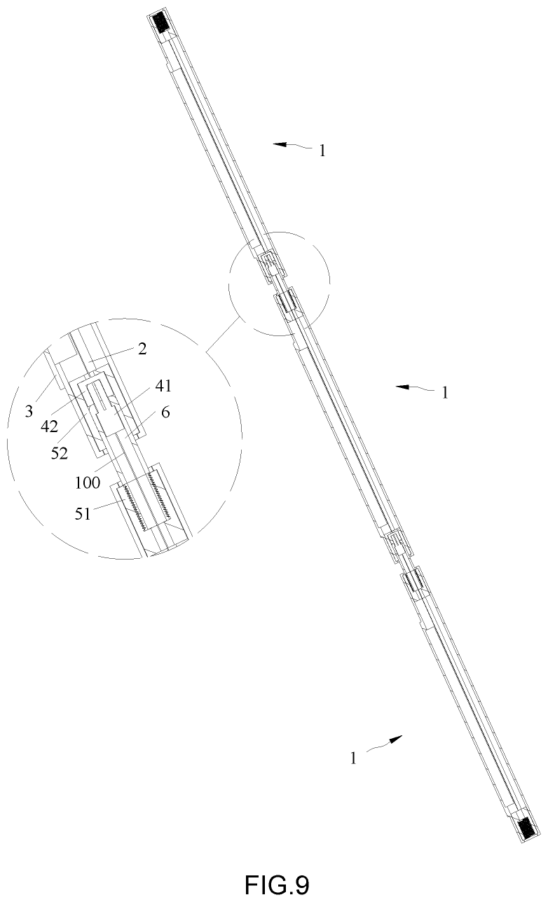

FIG. 10 is a perspective view of Embodiment I of the combined lamp;

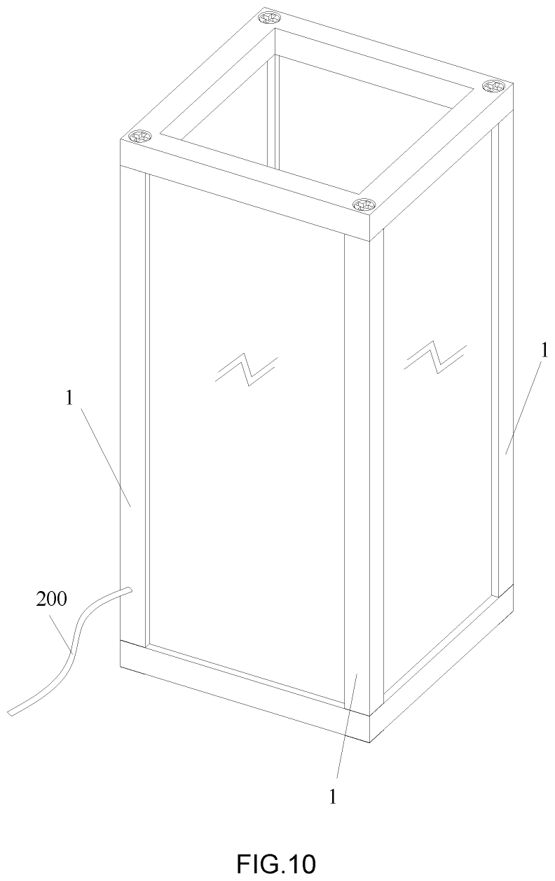

FIG. 11 is a perspective view of Embodiment II of the combined lamp.

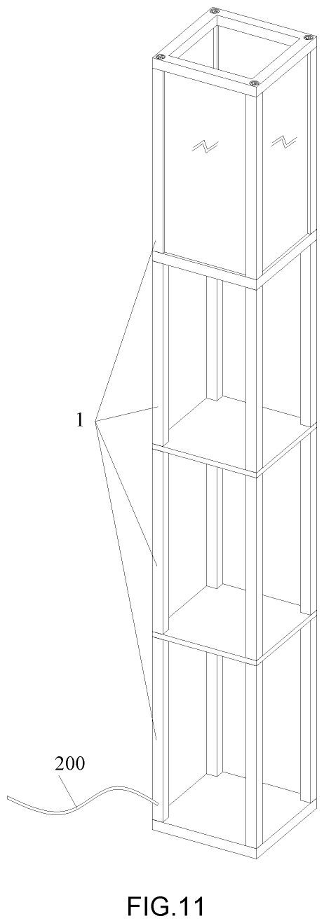

### DETAILED DESCRIPTION OF THE INVENTION

The technical solutions of the present utility model will be described more clearly and fully in conjunction with the accompanying drawings of the present utility model, and obviously, the described embodiments are merely a part of the embodiments of the present utility model, not all the embodiments. Based on the embodiments of the present utility model, all the other embodiments obtained by the ordinary skilled in the art without creative labors belong to the scope claimed by the present utility model.

It should be noted that if an embodiment of the present utility model relates to directive instructions (such as upper, lower, left, right, front, rear, top, bottom, inside, outside, vertical, transverse, longitudinal, counter-clockwise, clockwise, circumferential, radial and axial), these directive instructions are merely used to explain the relative position relationship, the movement and so on among the components at certain specific posture (as shown in the accompanying drawings); if the specific posture changes, the directive instructions should be changed accordingly.

In addition, if an embodiment of the present utility model relates to the descriptions such as “first” and “second”, these descriptions are merely used for description and should not be understood to indicate or imply their relative importance or implicitly indicate the number of the corresponding technical features. This shows that the features limited with “first” and “second” can explicitly or implicitly include one such feature at least. Moreover, the technical solutions among the embodiments can be in combination with each other; however, such combination must be on the premise that those skilled in the art can realize the related technical solutions; when the technical solutions are inconsistent or cannot be realized, such combination of technical solutions should be deemed to be inexistent and not in the scope claimed by the present utility model.

The present utility model provides a column.

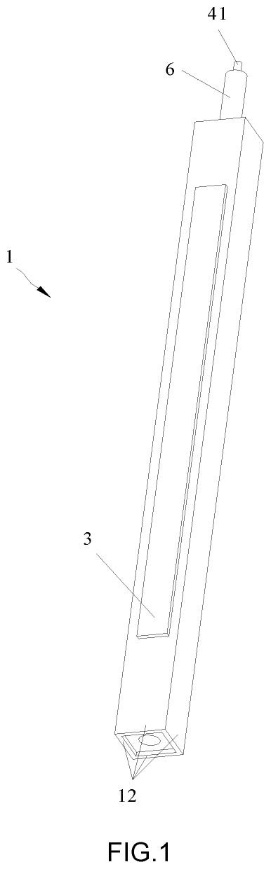

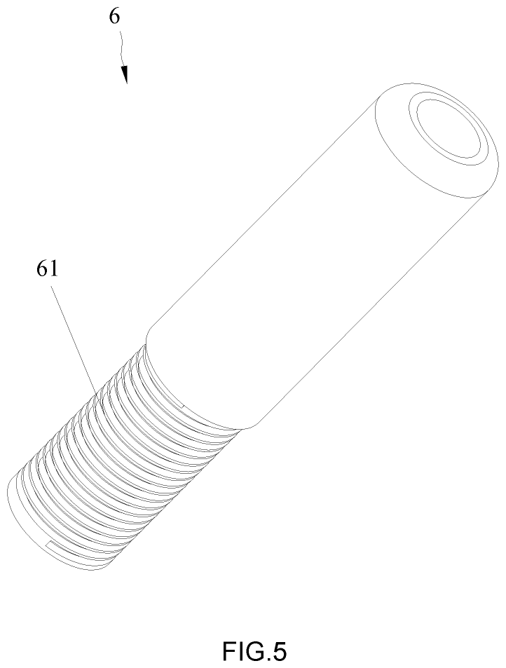

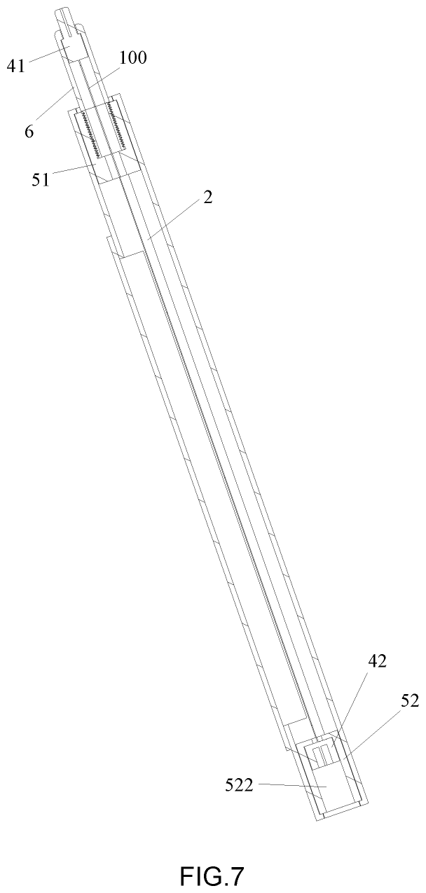

In an embodiment of the present utility model, as shown in FIG. 1 to FIG. 7, the column comprises an LED light strip (2), a conductive subassembly and at least one hollow column body (1), wherein on the side of the column body (1) is arranged with a light-transmitting opening (11) connected to the hollow area of the column body (1), on the said light-transmitting opening (11) is arranged with a light-transmitting sheet (3), and the said LED light strip (2) is mounted in the column body (1), the said conductive subassembly is electrically connected with the LED light strip (2) for connecting the LED light strip (2) with the external power supply.

In the technical solution of the present utility model, the column apparatus used for the combined lamp is arranged as at least one hollow column body, and in the hollow area of the column body is arranged with LED light strip(s); on the side of the column body is arranged with a light-transmitting opening connected to the hollow area of the column body, on the light-transmitting opening is arranged with a light-transmitting sheet as well as a conductive subassembly electrically connected to the LED light strip(s); the column in the present utility model can be formed by a single column body or formed by a plurality of columns which are connected in a vertically adjacent manner; the LED light strips on two adjacent columns can be connected via the conductive subassembly; when the column is used to form the frame of the combined lamp, the LED light strip(s) arranged on the column body can be used for lighting to increase the illumination intensity of the combined lamp and the diversity of the frame of the combined lamp and thus improve the practicability of the combined lamp.

Concretely, the column body (1) is surrounded by a plurality of column walls (12), and at least one end of the column body (1) is arranged with the said conductive subassembly.

Concretely, the conductive subassembly comprises a male power connector (41) arranged at the upper end of the column body (1) and electrically connected with the LED light strip (2) and/or a female power connector (42) arranged at the lower end of the column body (1) and electrically connected with the LED light strip (2); the male power connector (41) can be connected with the female power connector (42) to enable the LED light strips (2) on two adjacent columns to realize electrical connection.

Understandably, when the column is composed of one column body, the LED light strip in the column body can be connected with the external power supply via the power cord (200), the upper and lower ends of the column body can be connected with the external objects via the first screw aperture and the second screw aperture.

Understandably, when the column is composed of a plurality of column bodies, the top of the column body at the top of the column (namely the upper end of the column) is not installed with a male power connector, and the bottom of the column body at the bottom of the column (namely the lower end of the column) is not installed with a female power connector.

Concretely, at the positions in the column body (1) corresponding to the upper end and the lower end of the column body (1) are arranged respectively with a first fixing block (51) which can close the opening at the upper end of the column body (1) and a second fixing block (52) which can close the opening at the lower end of the column body (1); the top wall of the first fixing block (51) is arranged with a first screw aperture (511) and the bottom wall of the second fixing block (52) is arranged with a second screw aperture (521) or a slot (522); the male power connector (41) is detachably arranged on the first fixing block (51), and the female power connector (42) is arranged in the slot (522).

Concretely, the first screw aperture (511) is screwed with a connecting piece (6) that can be inserted into the said slot (522), the male power connector (41) is fixed onto the top of the connecting piece (6) and can be connected with the female power connector (42) after the connecting piece (6) is inserted into the slot (522) to realize the electrical connection of the LED light strips on two adjacent columns and also realize detachable fixed connection of two adjacent columns through the connection of the connecting piece (6) with the slot (522).

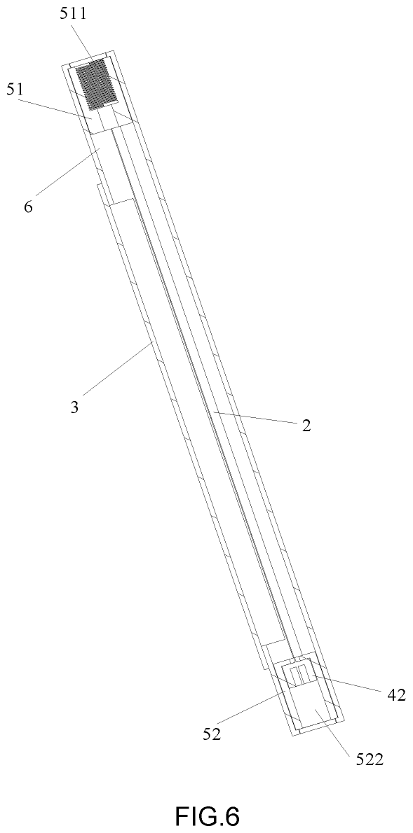

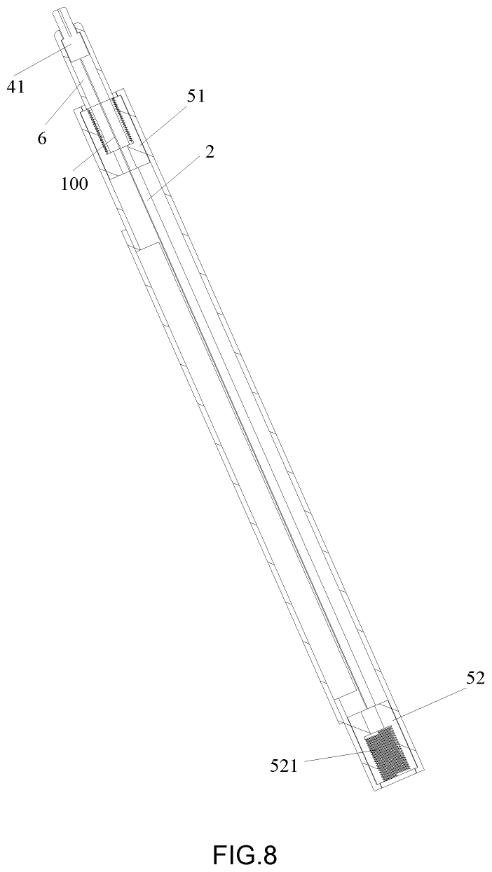

Understandably, as shown in FIG. 6 to FIG. 8, when the second fixing block is arranged with a slot, it can be used for plug-in connection with the connecting pieces on adjacent columns; when the second fixing block is arranged with a second screw aperture, the second screw aperture can be connected with the external objects (such as the support plate of the combined lamp) via screws; when the first screw aperture is not screwed with a connecting piece, the first screw aperture can be connected with the external objects (such as the top plate of the combined lamp) via screws; when the first screw aperture is screwed with a connecting piece, it can be inserted and connected with the slot on the adjacent column.

Concretely, the connecting piece (6) is a hollow structure with two openings at both ends, the lower end of the connecting piece (6) is a threaded part (61) that can be screwed with the first screw aperture (511), the male power connector (41) is fixed inside the connecting piece (6) and the coupling end of the male power connector (41) is exposed outside after passing through the upper-end opening of the connecting piece (6).

Concretely, the first screw aperture (511) and the slot (522) are connected with the hollow area of the column body (1) so that the male power connector (41) and the female power connector (42) are electrically connected with the LED light strip (2) via the wire (100).

Concretely, there are at least three column walls (12) forming the column body (1) and each end of each column wall (12) is arranged with a slope of 45 degrees.

Concretely, the cross section of the said column body (1) is polygonal or circular; when it is polygonal, at least one of the said light-transmitting openings (11) will be arranged on the side wall of the column body (1) or at the transitional position between two adjacent side walls of the column body (1); when it is circular, at least one of the said light-transmitting openings (11) will be arranged on the peripheral wall of the said column body (1).

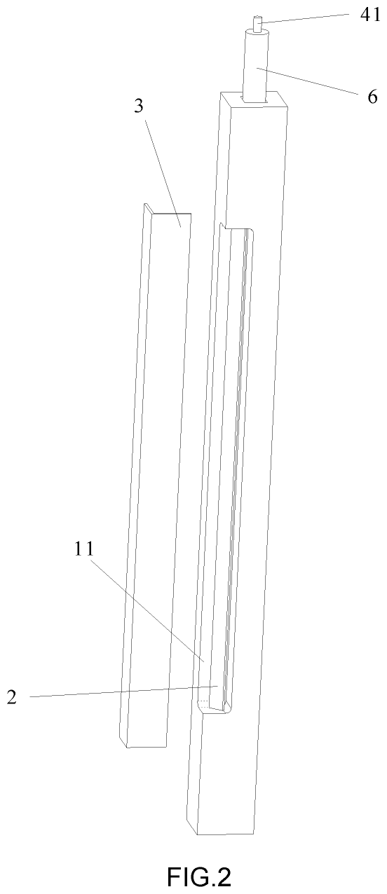

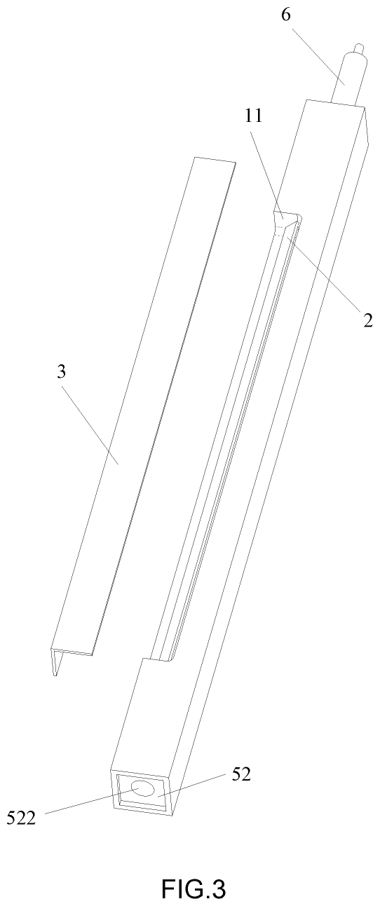

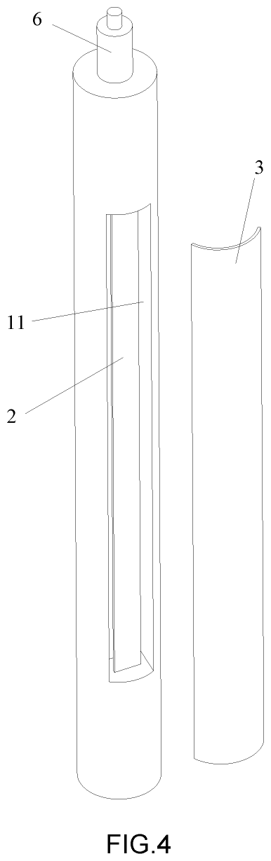

Understandably, as shown in FIG. 4, when the cross section of the said column body is circular, the said light-transmitting sheet will take on an arc shape. As shown in FIG. 1, when the light-transmitting opening is arranged on the side wall of the column body, the said light-transmitting sheet will take on a sheet shape. As shown in FIG. 2 and FIG. 3, when the light-transmitting opening is arranged at the transitional position between two adjacent side walls of the column body, the said light-transmitting sheet will take on an L shape.

The present utility model also provides a combined lamp comprising a column, wherein the said column can be subject to the embodiments described above; the combined lamp adopts all the technical solutions in all embodiments of the column described above. Therefore, the combined lamp at least possesses all the beneficial effects arising from the technical solutions of the embodiments described above, and thus not described one by one here.

It should be noted that other structures of the combined lamp can be subject to the prior art, and thus its specific structures and principles are not described here.

The embodiments described above are merely the preferred embodiments of the present utility model, not to limit the patent scope of the present utility model; with the conception of the present utility model, any equivalent structure transformation using the Specifications and the accompanying drawings of the present utility model or direct/indirect applications to other related technical fields should be included in the scope claimed by the present utility model.

What is claimed is:

1. A column, which is characterized in that it comprises an LED light strip (2), a conductive subassembly and at least one hollow column body (1), wherein on the side of the column body (1) is arranged with a light-transmitting opening (11) connected to the hollow area of the column body (1), on the said light-transmitting opening (11) is arranged with a light-transmitting sheet (3), and the said LED light strip (2) is mounted in the column body (1), the said conductive subassembly is electrically connected with the LED light strip (2) for connecting the LED light strip (2) with the external power supply.

2. The column in accordance with claim 1, which is characterized in that the column body (1) is surrounded by a plurality of column walls (12), and at least one end of the column body (1) is arranged with the said conductive subassembly.

3. The column in accordance with claim 1, which is characterized in that the conductive subassembly comprises a male power connector (41) arranged at the upper end of the column body (1) and electrically connected with the LED light strip (2) and/or a female power connector (42) arranged at the lower end of the column body (1) and electrically connected with the LED light strip (2); the male power connector (41) can be connected with the female power connector (42) to enable the LED light strips (2) on two adjacent columns to realize electrical connection.

4. The column in accordance with claim 3, which is characterized in that at the positions in the column body (1) corresponding to the upper end and the lower end of the column body (1) are arranged respectively with a first fixing block (51) which can close the opening at the upper end of the column body (1) and a second fixing block (52) which can close the opening at the lower end of the column body (1); the top wall of the first fixing block (51) is arranged with a first screw aperture (511) and the bottom wall of the second fixing block (52) is arranged with a second screw aperture (521) or a slot (522); the male power connector (41) is detachably arranged on the first fixing block (51), and the female power connector (42) is arranged in the slot (522).

5. The column in accordance with claim 4, which is characterized in that the first screw aperture (511) is screwed with a connecting piece (6) that can be inserted into the said slot (522), the male power connector (41) is fixed onto the top of the connecting piece (6) and can be connected with the female power connector (42) after the connecting piece (6) is inserted into the slot (522) to realize the electrical connection of the LED light strips on two adjacent columns and also realize detachable fixed connection of two adjacent columns through the connection of the connecting piece (6) with the slot (522).

6. The column in accordance with claim 5, which is characterized in that the connecting piece (6) is a hollow structure with two openings at both ends, the lower end of the connecting piece (6) is a threaded part (61) that can be screwed with the first screw aperture (511), the male power connector (41) is fixed inside the connecting piece (6) and the coupling end of the male power connector (41) is exposed outside after passing through the upper-end opening of the connecting piece (6).

7. The column in accordance with claim 4, which is characterized in that the first screw aperture (511) and the slot (522) are connected with the hollow area of the column body (1) so that the male power connector (41) and the female power connector (42) are electrically connected with the LED light strip (2) via the wire

8. The column in accordance with claim 2, which is characterized in that there are at least three column walls (12) forming the column body (1) and each end of each column wall (12) is arranged with a slope of 45 degrees.

9. The column in accordance with claim 1, which is characterized in that the cross section of the said column body (1) is polygonal or circular; when it is polygonal, at least one of the said light-transmitting openings (11) will be arranged on the side wall of the column body (1) or at the transitional position between two adjacent side walls of the column body (1), and the said light-transmitting sheet will take on a sheet shape or an L shape as a whole; when it is circular, at least one of the said light-transmitting openings (11) will be arranged on the peripheral wall of the said column body (1), and the said light transmitting sheet will take on an arc shape as a whole.

10. A combined lamp, which is characterized in that it comprises the column in accordance with claim 6.
